(19) United States
(12) Patent Application Publication
(10) Pub. No.: US 2006/0290891 A1
(43) Pub. Date: Dec. 28, 2006

(54) Device for cooling light emitting diode projector

(75) Inventors: Chin-Wen Wang, Gueishan Township (TW); Ching-Chung Wang, Gueishan Township (TW); Pei-Choa Wang, Gueishan Township (TW)

Correspondence Address: HDSL, 4331 STEVENS BATTLE LANE, FAIRFAX, VA, 22033, US

(73) Assignee: Augux Co., Ltd.

(21) Appl. No.: 11/159,181

(22) Filed: Jun. 23, 2005

(51) Int. Cl. G03B 21/16

(52) U.S. Cl. 353/52

(57) ABSTRACT

A device for cooling a light emitting diode projector includes a first cooling unit that includes a hollow portion. One end of the hollow portion includes a third cooling body and a reflection cover. The light emitting unit is adhered to one surface of the third cooling body, while the light source is projected corresponding to the reflection cover. A connection unit is disposed on the other end of the hollow portion, which can convey power source to the light emitting unit. The heat generated from the light emitting unit is directly absorbed into the third cooling body, and is transferred to the first cooling unit for performing heat exchange. The light emitting diode projector can thus obtain a better cooling effect.

### BACKGROUND OF THE INVENTION

The present invention relates generally to a light emitting diode (LED) projector, and more particularly to a device for cooling the LED projector.

A conventional projector is illustrated in FIG. 9. As shown, the conventional projector includes a cover 6 made of aluminum extrusion fins. The cover 6 is used as a reflection cover. A light emission portion 61 of high brightness is disposed on the top portion of the cover 6, so as to allow the projector being disposed to some position for partially enhancing the light source.

Although the conventional projector described above can partially enhance the light source, the high brightness light emitting portion 61 produces a heat source when emitting light. If the heat is not properly dissipated out, the light emitting portion 61 will be damaged when over heated. Therefore, it is an important issue to dissipate heat produced from the projector. With respect to the conventional projector, the cover 6 made of aluminum extrusion fins exchanges heat with the air outside. However, since the cover 6 and the light emitting portion 61 is purely contacting with each other, no transfer media is disposed therebetween. For this reason, the heat transfer rate of the light emitting portion 61 is lower, which hinders the heat source to rapidly be transferred to the cover 6 for performing heat exchange with the air outside. In this manner, most of the heat will be accumulated on the light emitting portion 61, which will shorten the life span of the light emitting portion 61.

### BRIEF SUMMARY OF THE INVENTION

The present invention is to provide a device that can effectively dissipate heat generated from a light emitting diode projector.

In order to achieve the above and other objectives, the device for cooling a light emitting diode project of the present invention includes a first cooling unit that includes a hollow portion. One end of the hollow portion includes a third cooling body and a reflection cover. The light emitting unit is adhered to one surface of the third cooling body, while the light source is projected corresponding to the reflection cover. A connection unit is disposed on the other end of the hollow portion.

### BRIEF DESCRIPTION OF THE DRAWINGS

FIG. 1 is an explosive view of a light emitting diode projector of the present invention.

FIG. 2 is a perspective view of the light emitting diode projector of the present invention.

FIG. 3 is a sectional view of the light emitting diode projector of the present invention.

FIG. 4 is a top elevation of the light emitting diode projector of the present invention.

FIG. 5 is a sectional view of the light emitting diode projector, in accordance with one embodiment of the present invention.

FIG. 6 is a sectional view of the light emitting diode projector, in accordance with another embodiment of the present invention.

FIG. 7 is a sectional view of the light emitting diode projector, in accordance with still another embodiment of the present invention.

FIG. 8 is a sectional view of the light emitting diode projector, in accordance with yet another embodiment of the present invention.

FIG. 9 is a perspective view of a conventional light emitting diode projector.

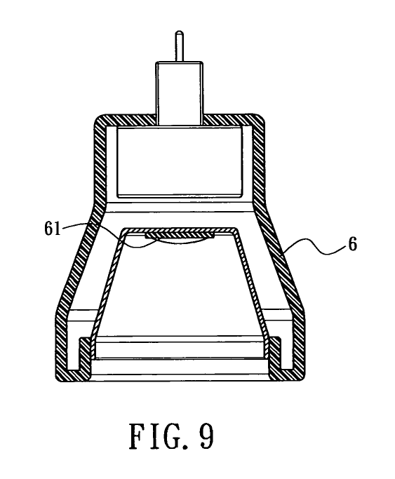

### DETAILED DESCRIPTION OF THE INVENTION

In order to better understanding the features and technical contents of the present invention, the present invention is hereinafter described in detail by incorporating with the accompanying drawings. However, the accompanying drawings are only for the convenience of illustration and description, no limitation is intended thereto.

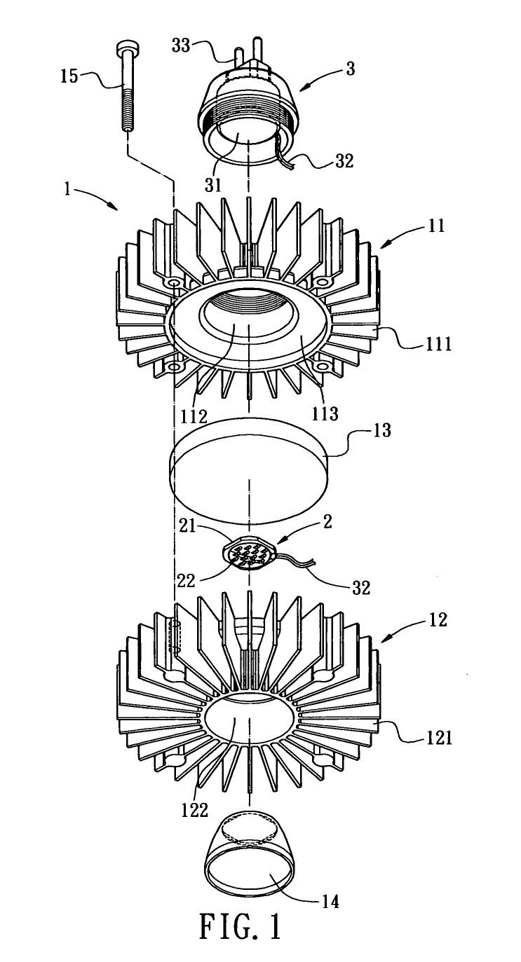

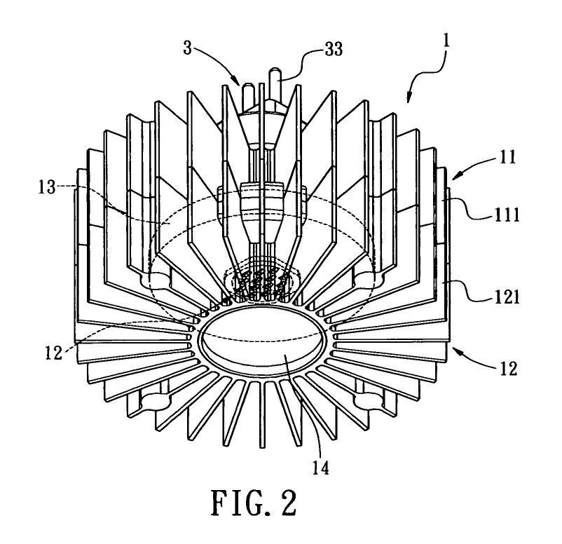

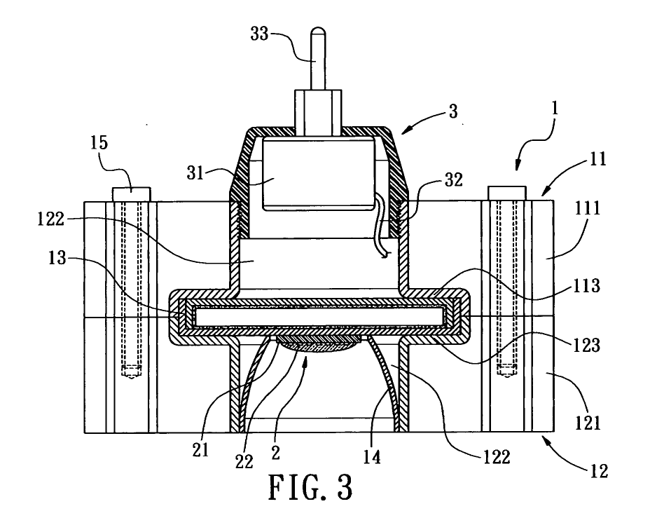

Referring to FIG. 1, FIG. 2 and FIG. 3, an explosive view, a perspective view and a sectional view of a device for cooling a light emitting diode projector of the present invention are illustrated. The cooling device includes a first cooling unit 1, a light emitting unit 2 and a connection unit 3, whereby the cooling device can dissipate heat generated from the light emitting diode projector.

The first cooling unit 1 includes a first cooling body 11 and a second cooling body, both of which are composed of a plurality of cooling fins 111, 121. A retaining space 113, 123 is respectively formed on the first cooling body 11 and the second cooling body 12 for retaining therein a third cooling body 13. The retaining spaces 113, 123 includes hollow portions 112, 122. A reflection cover 14 is disposed in the hollow portion 122 of the second cooling body 12, while the first cooling body 11 and the second cooling body 12 are securely fastened with each other via a fastening element 15.

The light emitting unit 2 includes a circuit board 21, and a plurality of light emitters 22 packaged on the circuit board 21. In one particular embodiment, the light emitters 22 are light emitting diodes (LEDs). The circuit board 21 is adhered to one surface of the third cooling body 13, which includes a constant temperature plate. The light emitter 22 corresponds the reflection cover 14 disposed on the second cooling body 12.

The connection unit 3 is disposed on one end of the hollow portion 112 of the first cooling body 11. A transformer 31 is disposed in the connection unit 3, while a connection end 33 that is accessible to a power source is formed outside of the connection unit 3. The transformer 31 is connected to the light emitting unit 2 of circuit board 21 via a conducting cable 32. After the connection end 33 is plugged into the power source outlet, the power source enters the transformer 31 and transforms to the power source that can light up the light emitting unit 2.

In this manner, a brand new device for cooling light emitting diode is constructed.

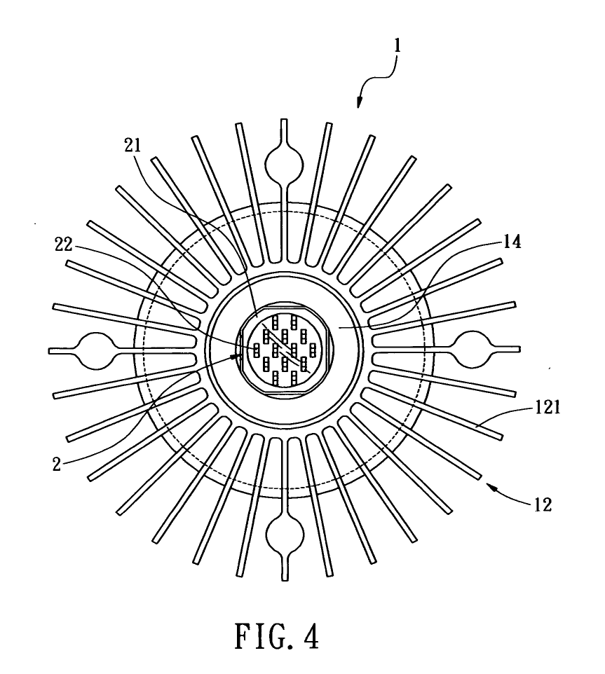

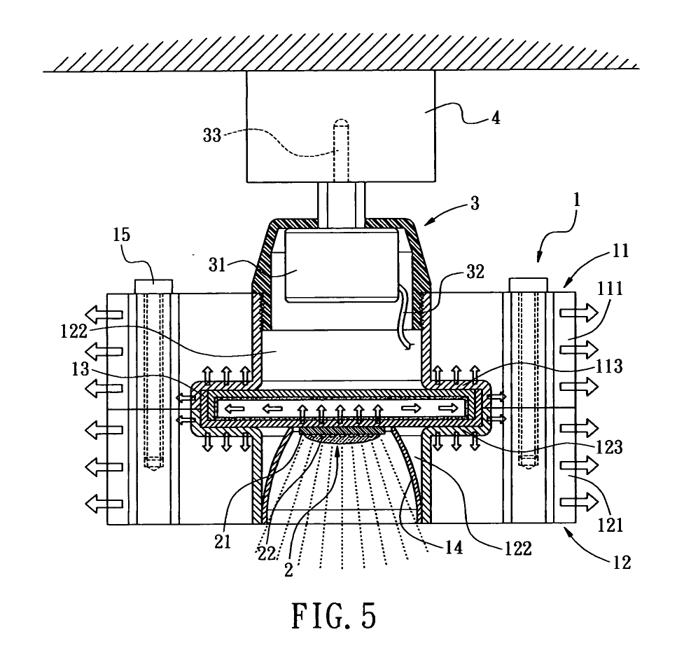

Referring to FIG. 4 and FIG. 5, a top elevation and a section view of the present invention are illustrated. When the present invention is in use, one can connect the connection end 33 of the connection unit 3 to an external power source 4, so as to transform the external power source and provide the light emitters 22 of the light emitting unit 2 the required power source. The heat source generated from the light emitters 22 is absorbed directly into the third cooling body 13. The third cooling body 13 then transfers the heat to the first cooling body 11 and the second cooling body 12 of the cooling unit 1. The heat is further transferred to each of the cooling fins 111, 112, so as to dissipate the heat to the environment, thereby extending the life span of the LED projector.

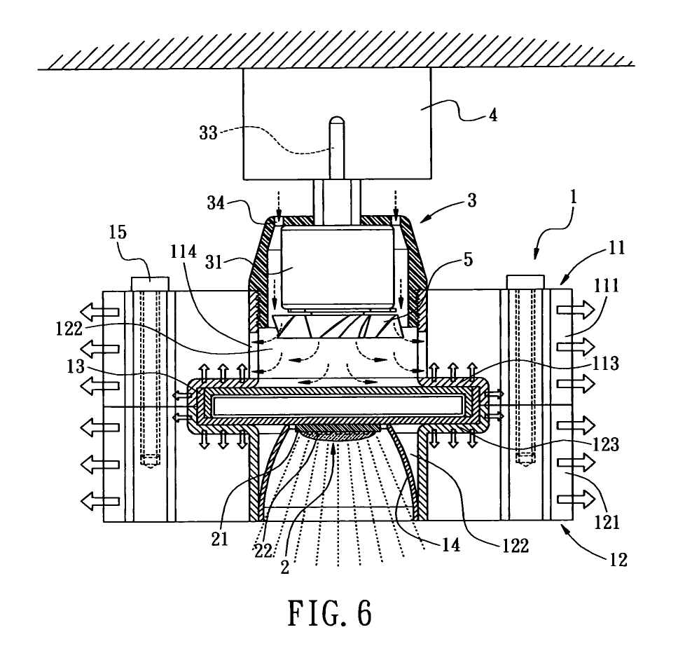

Referring to FIG. 6, the cooling device in accordance with another embodiment of the present embodiment is illustrated. As shown, a second cooling unit 5 is disposed between the connection unit 3 and the third cooling body 13. The second cooling unit 5 can be a fan. A plurality of through holes 114 is formed on the walls of the hollow portion 112 of the first cooling body 11. A plurality of entrances 34 is formed at the end portion of the connection unit 3. When the second cooling unit 5 is rotating, the air from the environment can flow through the entrances 34 and towards the third cooling body 13. The air can further flow out via the through holes 114. A forced convection is thus formed, so as the enhance the cooling rate of the LED projector.

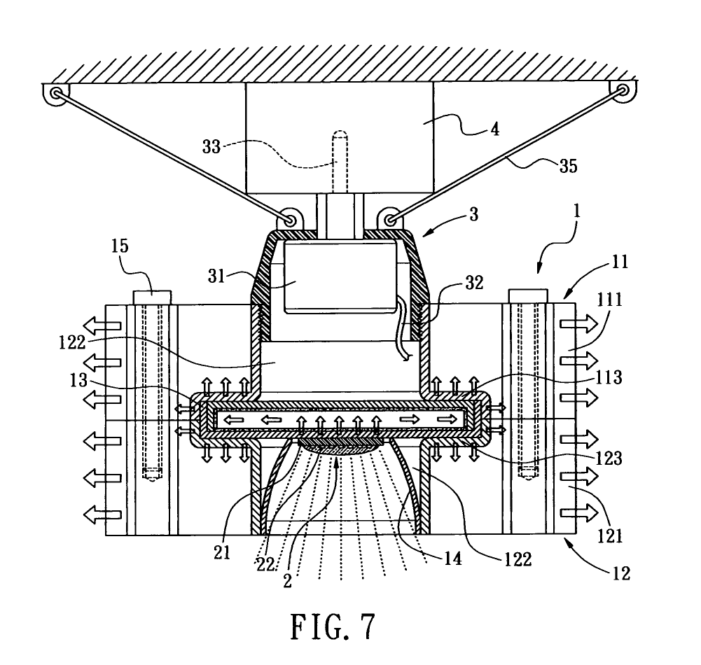

Referring to FIG. 7, the cooling device in accordance with still another embodiment of the present invention is illustrated. As shown, an additional hanger frame 35 can be formed outside of the connection unit 3, which provides the user to hang the LED projector on the ceiling, or any other position as necessary.

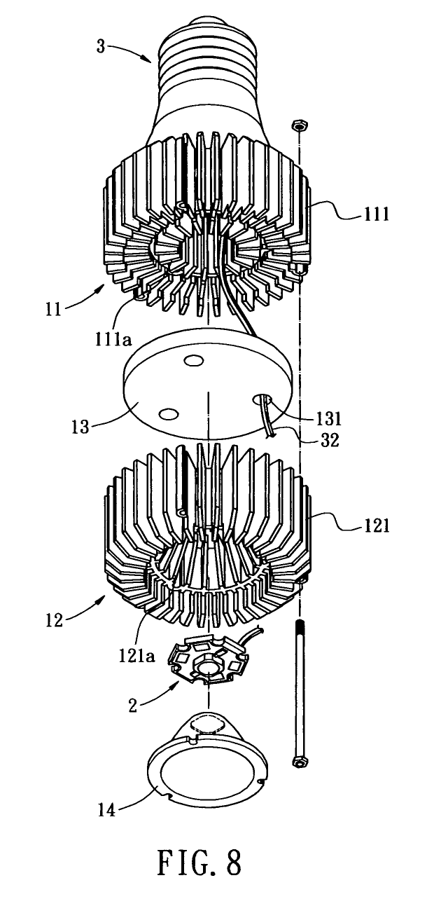

Referring to FIG. 8, the cooling device in accordance with yet another embodiment of the present invention is illustrated. As shown, the first cooling body 11 and the second cooling body 12 includes a plurality of radiatively formed fins 111, 111a, 121, 121a. A plurality of through holes 131 is formed on the third cooling body 13. The through holes 131 not only can allow heat to dissipate therefrom, but also can penetrate therethrough the conducting cable 32 for connecting with the light emitting unit 2. After the connection unit 3 and the power outlet (not shown) are connected, the power source is conveyed to the light emitting unit 2 via the conducting cable 32.

Since, any person having ordinary skill in the art may readily find various equivalent alterations or modifications in light of the features as disclosed above, it is appreciated that the scope of the present invention is defined in the following claims. Therefore, all such equivalent alterations or modifications without departing from the subject matter as set forth in the following claims is considered within the spirit and scope of the present invention.

What is claimed is:

1. A device for cooling a light emitting diode projector, comprising:
a first cooling unit including a hollow portion formed therein, the hollow portion comprising a third cooling body disposed therein;
a reflection cover disposed in the hollow portion;
a light emitting unit disposed on one surface of the third cooling body, wherein the light source is projected corresponding to the reflection cover; and
a connection unit disposed on one end of the hollow portion.

2. The device as recited in claim 1, wherein the first cooling unit comprises a first cooling body and a second cooling body, the first cooling body and the second cooling body, which are securely fastened with each other via a fastening element, including a retaining space for retaining therein the third cooling body, and a plurality of fins.

3. The device as recited in claim 2, wherein the first cooling body and the second cooling body comprise a plurality of radiatively formed fins.

4. The device as recited in claim 1, wherein the light emitting unit comprises a circuit board and a plurality of light emitters disposed on the circuit board, wherein the light emitters comprise light emitting diodes.

5. The device as recited in claim 4, wherein the connection unit comprises a transform, which is electrically connected with the light emitting unit on the circuit board via a conducting cable.

6. The device as recited in claim 1, wherein the connection uint comprises a connection end and a hanger frame formed at outside thereof.

7. The device as recited in claim 1, wherein the third cooling body comprises a constant temperature plate.

8. The device as recited in claim 7, wherein a plurality of through holes is formed on the third cooling body.

9. A device for cooling a light emitting diode projector, comprising:
a first cooling unit including a hollow portion, the hollow portion comprising a third cooling body, and at least a through hole on the walls of the hollow portion;
a reflection cover disposed in the hollow portion;
a light emitting unit disposed on one surface of the third cooling body, wherein the light source is projected corresponding to the reflection cover;
a connection unit disposed on one end of the hollow portion, which comprises an entrance communicable with inside of the connection unit; and
a second cooling unit, which is disposed in the hollow portion and is situated between the connection unit and the third cooling body.

10. The device as recited in claim 9, wherein the second cooling unit comprises a fan.
